(19) United States
(12) Patent Application Publication
(10) Pub. No.: US 2024/0109186 A1
(43) Pub. Date: Apr. 4, 2024

(54) SMART SENSORIZED GRIPPER

(71) Applicant: NATIONAL CHENG KUNG UNIVERSITY, Tainan City (TW)

(72) Inventor: Chao-Chieh LAN, Tainan City (TW)

(21) Appl. No.: 17/952,803

(22) Filed: Sep. 26, 2022

(51) Int. Cl. B25J 9/10; B25J 9/16

(52) U.S. Cl. CPC B25J 9/106; B25J 9/1694

(57) ABSTRACT

A smart sensorized gripper connected to and controlled by a controlling device comprises a gripper base, a driving assembly, two moving assemblies, two gripping assemblies, two angle sensors and a displacement sensor. The driving assembly and the sensors are disposed on the gripper base and connected to the controlling device. The driving assembly drives the gripping assemblies to grip and release an object through the moving assemblies. An axial force along a Z-direction and a gripping force along an X-direction of the smart sensorized gripper are controlled by sensing crank elements of the gripping assemblies with the angle sensors and sensing a displacement of a moving element of the driving assembly with the displacement sensor, increasing functionality and positioning precision. The sensors are disposed at the gripper base to avoid extra electrical wirings on the gripping assemblies, simplifying the wirings and reducing the cost.

### FIELD OF THE INVENTION

The present invention relates to a gripper, especially to a smart sensorized gripper which can sense an axial force along a Z-direction and a gripping force along an X-direction.

### DESCRIPTION OF THE PRIOR ARTS

A gripper is usually cooperated with a robotic arm or any other type of driving device to apply on automated operations. Based on different operational needs, the conventional grippers are provided in different types, such as a rigid gripper, soft gripper, sensorized gripper, etc.

Among the grippers, the rigid gripper does not have a function of sensing a gripping force and therefore does not have a function of force feedback, so it is difficult to immediately find out that the gripper or an object to be gripped is damaged when the rigid gripper collides or when the gripping force is too strong. Thus the rigid gripper can be hardly applied on operations that require high precision. The soft gripper has flexibility but does not have the sensing function. Due to the flexibility, the soft gripper is less prone to damage to itself or damage to the object when colliding or gripping the object. However, the flexibility of the soft gripper leads to drawbacks such as difficulty in controlling the gripping force and the gripping position, and lack of stiffness along a non-gripping direction.

Applying the sensorized gripper on an automated precise operation nowadays is gradually becoming a trend. The sensorized gripper can sense the gripping force of its gripping portions toward the gripped object. The sensing methods of the sensorized gripper are normally divided into current type, capacitive type and resistive type. Among them, the current type is non-linear sensing and generates more noise, the sensing result therefore being less precise. The capacitive type and the resistive type sense through capacitive-pressure sensors or resistive-pressure sensors, which are mounted at the gripping portions of the sensorized gripper. While gripping, the sensorized gripper can sense the gripping force by the pressure sensors in contact with the gripped object. However, the electrical wirings are complicated and the cost is high because the pressure sensors need to be mounted at the gripping portions of the gripper.

### SUMMARY OF THE INVENTION

The present invention is to resolve the drawback that the sensing result of a current-type sensorized gripper is less precise, and that pressure sensors of capacitive-type and resistive-type sensorized grippers need to be mounted at gripping portions of the grippers, leading to complicated electrical wirings and high cost.

A smart sensorized gripper of the present invention is configured to be electrically connected to and controlled by a controlling device, and the smart sensorized gripper has a Z-direction and comprises a gripper base, a driving assembly, two gripping assemblies, two moving assemblies, two angle sensors and a displacement sensor. The driving assembly is mounted at the gripper base and comprises a driving element and a moving element. The driving element is electrically connected to and controlled by the controlling device. The moving element is connected to and driven by the driving element to move linearly along the Z-direction. The two gripping assemblies are mounted at the gripper base and are opposite to each other. Each one of the two gripping assemblies comprises two crank elements and a gripping element. The two crank elements are parallel to each other and are rotatably mounted at the gripper base respectively. The gripping element is connected to the two crank elements and has an elastic portion and a gripping portion, which is connected to the elastic portion and is disposed at an end away from the crank elements of the gripping element. The two moving assemblies are mounted at the gripper base and are opposite to each other. Each one of the two moving assemblies is corresponding to a respective one of the two gripping assemblies and comprises a driven bar and an elastic element. The driven bar has a moved end, which is linearly and movably mounted on the gripper base, and a pivot end, being opposite to the moved end, and rotatably connected to one of the two crank elements of the corresponding gripping assembly. The elastic portion has two ends along the Z-direction, and the two ends of the elastic portion are respectively connected to the moving element and the moved end of the driven bar. The two angle sensors are mounted at the gripper base, are electrically connected to the controlling device, and are respectively corresponding to the two gripping assemblies. Each one of the two angle sensors is configured to sense an angle of a respective one of the two crank elements of the corresponding gripping assembly. The displacement sensor is mounted at the gripper base, is electrically connected to the controlling device, and is configured to sense a displacement of the moving element.

The present invention can be controlled by the controlling device, such as a robotic arm, and can be driven by the controlling device. The controlling device can drive the driving element of the driving assembly to drive the two gripping assemblies by the two driving assemblies respectively, thereby moving the gripping portions of the gripping elements of the two gripping assemblies toward or away from each other. By that, the gripping elements of the two gripping assemblies can grip or release an object. The present invention has advantages as follows:
1. Sensing action forces along two directions: While the gripping elements of the two gripping assemblies are forced, the angle sensors will sense the rotational angle of the crank elements of the two gripping assemblies, and the displacement sensor will sense the displacement of the moving element along the Z-direction. After operation, the controlling device will get an amplitude of an axial force along the Z-direction and an amplitude of a gripping force along an X-direction being perpendicular to the Z-direction. In addition, by controlling the driving element, the controlling device can control a force along the Z-direction and a force along the X-direction that are applied on an object by the smart sensorized gripper. The present invention can be applied on collision detection and increase the object-gripping precision, thereby increasing the functionality of the smart sensorized gripper.
2. Increasing the sensing precision: As mentioned above, the two angle sensors sense the rotational angle of the crank elements, and the displacement sensor senses the displacement of the moving element. So the smart sensorized gripper detects the gripping force and the axial force by the sensors sensing the mechanical operation, thereby increasing the precision and reliability of sensing.
3. Reducing the production cost: As the two angle sensors and the displacement sensor are mounted at the gripper base, there is no need to install extra electrical wirings on the gripping elements, thereby simplifying the wiring and reducing the production cost. Additionally, by the sensing of the two angle sensors and the displacement sensor, the controlling device can control the two gripping assemblies to move with only one driving element of the driving assemblies. And the controlling device can control the gripping force and the axial force that are applied on the object by the smart sensorized gripper, thereby reducing the production cost and the total weight of the smart sensorized gripper.
4. Avoiding damaging the object: The gripping portion of the gripping element of the gripping assembly is connected to the elastic portion. As the elastic portion is elastically deformable, the gripping element can provide a soft gripping touch like a soft gripper while maintaining the stiffness. This provides a buffer to the gripping portion of the gripping element upon contacting the object or upon collision, thereby avoiding damage to the smart sensorized gripper or the object. Also by the elastic deformation of the elastic portion, a positioning error within a certain range can be overcome.

Besides, while sensing the axial force and the gripping force, the smart sensorized gripper is not affected by connecting directions of the elastic portion of the gripping element of each one of the two gripping assemblies. The connecting directions of the elastic portion are that the elastic portion can be connected to the gripping portion along the X-direction or along a direction nonparallel with the X-direction. Therefore the structural design of the smart sensorized gripper can be adjusted to meet the needs of manufacturers, enlarging the scope of application.

Preferably, the two moving assemblies are respectively disposed at two sides of the driving assembly, and the two gripping assemblies are respectively disposed at the two sides of the driving assembly. That is, the smart sensorized gripper is symmetrical at two sides of the Z-direction. Besides, the driving assembly comprises a driving screw rod mounted at the gripper base and connected to the driving element. The gripper base has two axial guideway rails. The moving element is screwed on the driving screw rod and movably mounted on the two axial guideway rails. The driving elements can rotate the driving screw rod, thereby moving the moving element on the driving screw rod and the two axial guideway rails along the Z-direction. So the operation stability of the smart sensorized gripper increases, thereby increasing the sensing precision.

Furthermore, the gripping element of each one of the two gripping assemblies has a base-connecting portion connected to the two crank elements. In one embodiment of the present invention, one end of the elastic portion is connected to the base-connecting portion, and another end of the elastic portion is connected to the gripping portion. While in other embodiments of the present invention, a gripper guideway is mounted on the base-connecting portion; one end of the elastic portion is connected to the base-connecting portion, and another end of the elastic portion is movably mounted at the gripper guideway and is connected to the gripping portion. Additionally, the gripper guideway is along a direction at an angle with the X-direction, so the elastic portion can be connected to the gripping portion along the said direction that is at the angle with the X-direction. Therefore the configuration of the gripping portion can be changed, which enlarges the application scope of the smart sensorized gripper. With the gripper guideway, a range of the forced-to-move distance of the gripping element is increased for manufacturers to choose according to needs.

### BRIEF DESCRIPTION OF THE DRAWINGS

FIG. 1 is a perspective view of a first embodiment of a smart sensorized gripper in accordance with the present invention;

FIG. 2 is a front view of the first embodiment of the smart sensorized gripper in FIG. 1;

FIG. 3 is a rear view of the first embodiment of the smart sensorized gripper in FIG. 1;

FIG. 4 is a side view of the first embodiment of the smart sensorized gripper in FIG. 1;

FIG. 5 is a perspective view of a second embodiment of the smart sensorized gripper in accordance with the present invention;

FIG. 6 is a front view of the second embodiment of the smart sensorized gripper in FIG. 5;

FIG. 7 is a perspective view of a third embodiment of the smart sensorized gripper in accordance with the present invention;

FIG. 8 is a front view of the third embodiment of the smart sensorized gripper in FIG. 7;

FIG. 9 is a front view of the two gripping portions of the two gripping elements of the first embodiment of the smart sensorized gripper, moving away from each other;

FIG. 10 is a front view of the two gripping portions of the two gripping elements of the first embodiment of the smart sensorized gripper, moving toward each other;

FIG. 11 is a partial simplified view of the driving assembly, the gripping assembly and the moving assembly of the first and second embodiments of the smart sensorized gripper;

FIG. 12 is a partial simplified view of the driving assembly, the gripping assembly and the moving assembly of the third embodiment of the smart sensorized gripper; and

FIG. 13 is an operational view of the smart sensorized gripper, gripping an object.

### DETAILED DESCRIPTION OF THE PREFERRED EMBODIMENTS

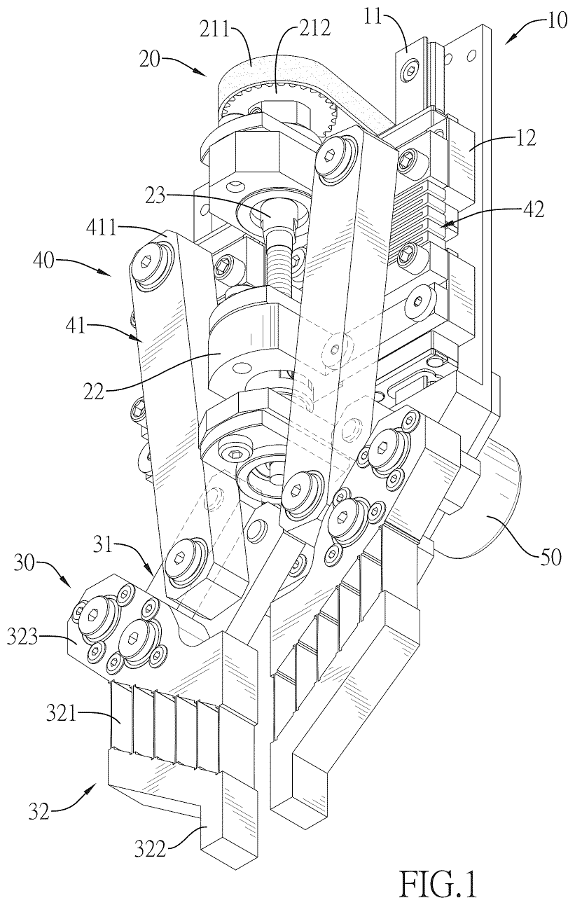

FIGS. 1 to 4 show a first embodiment of a smart sensorized gripper in accordance with the present invention. The smart sensorized gripper is electrically connected to and controlled by a controlling device. The smart sensorized gripper has a Z-direction and comprises a gripper base 10, a driving assembly 20, two gripping assemblies 30, two moving assemblies 40, two angle sensors 50 and a displacement sensor 60.

With reference to FIGS. 1 to 4, the driving assembly 20 is mounted at the gripper base 10 and comprises a driving element 21, electrically connected to and controlled by the controlling device, and a moving element 22 connected to and driven by the driving element 21 to move linearly along the Z-direction. Preferably, the driving element 21 is a motor.

With reference to FIGS. 1 to 3, the two gripping assemblies 30 are mounted at the gripper base 10 and are opposite to each other. Each one of the two gripping assemblies 30 comprises two crank elements 31, which are parallel to each other and are rotatably mounted at the gripper base 10 respectively, and a gripping element 32 connected to the two crank elements 31. The gripping element 32 has an elastic portion 321 and a gripping portion 322 connected to the elastic portion 321 and disposed at an end, which is away from the crank elements 31, of the gripping element 32. Preferably, the elastic portion 321 is a compression spring.

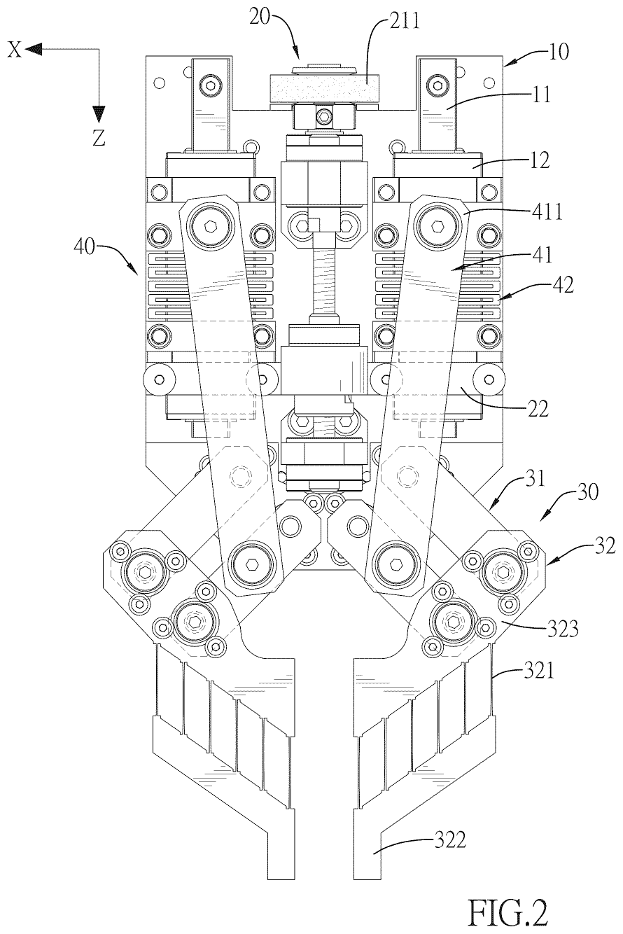

With reference to FIGS. 1 and 2, the two moving assemblies 40 are mounted at the gripper base 10 and are opposite to each other. Each one of the two moving assemblies 40 is corresponding to a respective one of the two gripping assemblies 30 and comprises a driven bar 41 and an elastic element 42. The driven bar 41 has a moved end 411, which is linearly and movably mounted on the gripper base 10, and a pivot end, being opposite to the moved end 411, and rotatably connected to one of the two crank elements 31 of the corresponding gripping assembly 30. The elastic element 42 has two ends along the Z-direction, and the two ends of the elastic element 42 are respectively connected to the moving element 22 and the moved end 411 of the driven bar 41. Preferably, the elastic element 42 is a compression spring, more preferably a flat spring. Compared to a coil spring, the flat spring has advantages that two ends of the flat spring are easy to fix and small in size, therefore applying the flat spring on the present invention can increase the structural stability and reduce the volume.

In addition, the driving assembly 20 comprises a driving screw rod 23 mounted at the gripper base 10 and connected to the driving element 21. The gripper base 10 has two axial guideway rails 11. The moving element 22 is screwed on the driving screw rod 23 and is movably mounted on the two axial guideway rails 11. The driving element 21 rotates the driving screw rod 23, thereby moving the moving element 22 on the driving screw rod 23 and the two axial guideway rails 11 along the Z-direction. The moved end 411 of the driven bar 41 of each one of the two moving assemblies 40 is respectively mounted at a respective one of the two axial guideway rails 11.

Furthermore, an axial guideway carriage 12, at which the moved end 411 of the driven bar 41 of each one of the two moving assemblies 40 is respectively and rotatably mounted, is mounted on one of the two axial guideway rails 11, and therefore the said moved end 411 of the said driven bar 41 can be moved on the gripper base 10 linearly. The two ends of the elastic element 42 of the said moving assembly 40 are respectively connected to the moving element 22 of the driving assembly 20 and the axial guideway carriage 12, at which the moved end 411 of the corresponding driven bar 41 is mounted, along the Z-direction.

Preferably, the two moving assemblies 40 are respectively disposed at two sides of the driving assembly 20, and the two gripping assemblies 30 are respectively disposed at the two sides of the driving assembly 20 with the corresponding moving assemblies 40. The two axial guideway rails 11 of the gripper base 10 are disposed at two sides of the driving screw rod 23 respectively. A distance between the moved end 411 of the driven bar 41 and the driving screw rod 23 is longer than a distance between the pivot end and the driving screw rod 23 such that the smart sensorized gripper is symmetrical at two sides of the Z-direction, cooperating with that the moving element 22 is mounted at the two axial guideway rails 11, thereby increasing the operation stability of the smart sensorized gripper and the sensing precision as well.

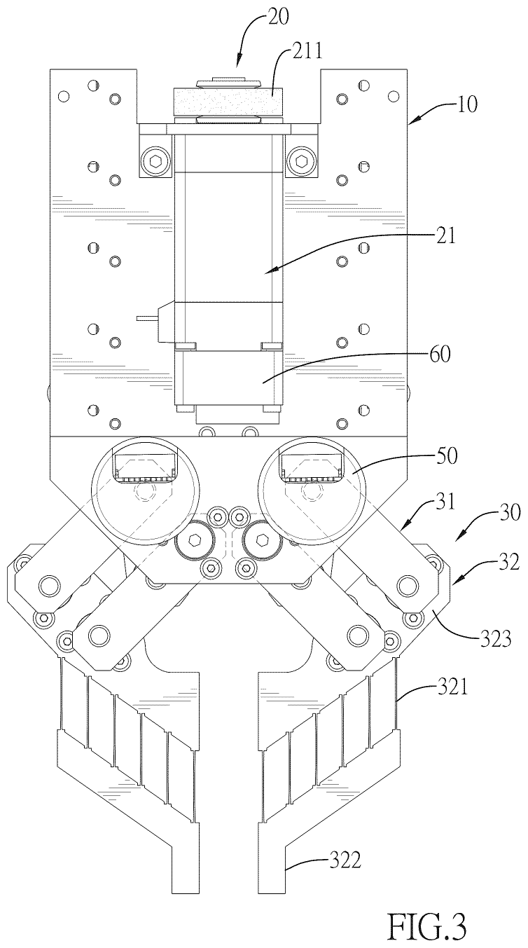

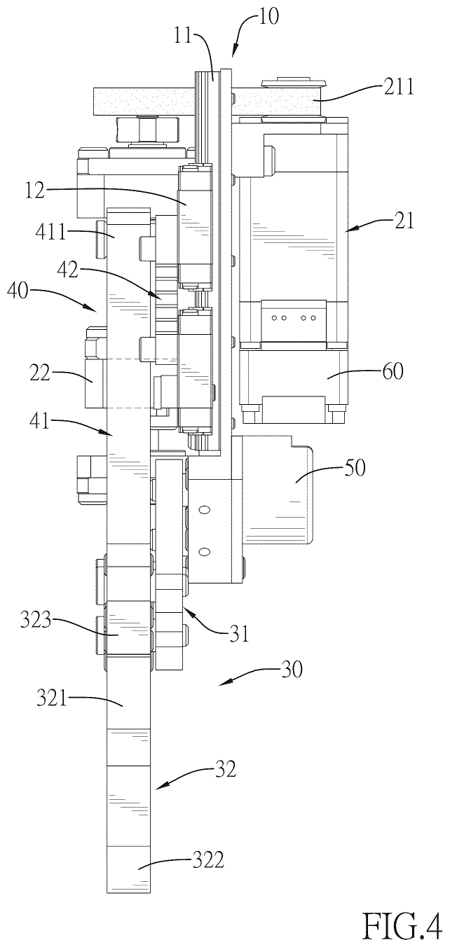

With reference to FIGS. 3 and 4, the two angle sensors 50 are mounted at the gripper base 10, are corresponding to the two gripping assemblies 30, and are electrically connected to the controlling device respectively. Each one of the two angle sensors 50 is configured to sense an angle of a respective one of the two crank elements 31 of the corresponding gripping assembly 30. As the two crank elements 31 are parallel to each other, when the two crank elements 31 are driven to rotate, their rotating angles are the same.

With reference to FIGS. 3 and 4, the displacement sensor 60 is mounted at the gripper base 10, is electrically connected to the controlling device, and is configured to sense a displacement of the moving element 22. Additionally, the two angle sensors 50 and the displacement sensor 60 are preferably optical encoders. Furthermore, the two gripping assemblies 30 and the two moving assemblies 40 are mounted at a front side of the gripper base 10, while the two angle sensors 50, the displacement sensor 60 and the driving element 21 are mounted at a rear side of the gripper base 10.

With reference to FIG. 2, the smart sensorized gripper has an X-direction perpendicular to the Z-direction. The gripping element 32 of each one of the two gripping assemblies 30 has a base-connecting portion 323 connected to the two crank elements 31 of the said gripping assembly 30. In the first embodiment of the present invention, the elastic portion 321 of the gripping element 32 of each one of the two gripping assemblies 30 is directly connected to the base-connecting portion 323 and the gripping portion 322. Furthermore, the gripping element 32 is one-piece formed, thereby reducing the cost and downsizing.

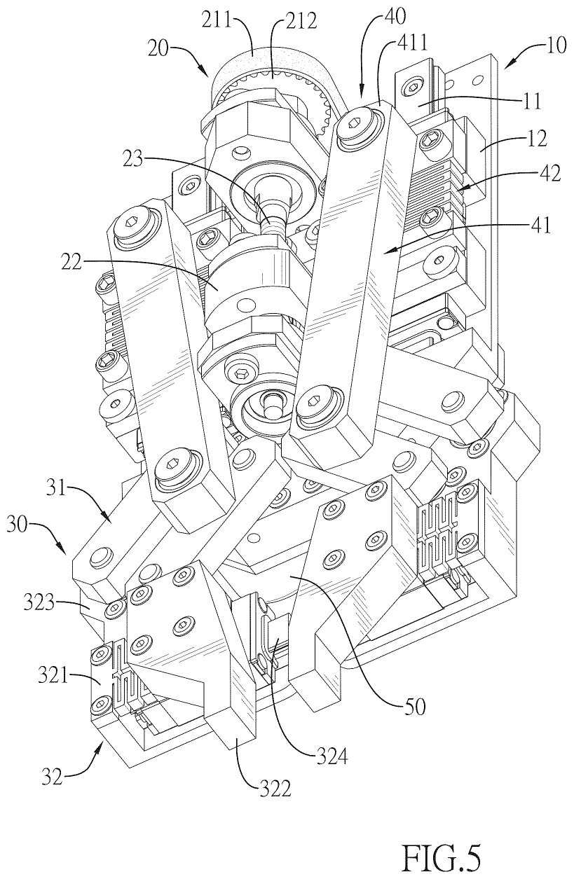

Moreover, with reference to FIGS. 5 to 8, in the second and third embodiments of the present invention, a gripper guideway 324 is mounted on the base-connecting portion 323. One end of the elastic portion 321 is connected to the base-connecting portion 323, and another end of the elastic portion 321 is movably mounted at the gripper guideway 324 and is connected to the gripping portion 322. The gripper guideway 324 is along a direction nonparallel with the X-direction, and an angle θ_{b} is formed between the said direction and the X-direction, wherein the angle θ_{b} is between 0 and 90 degrees, endpoints excluded. By that, the elastic portion 321 can be connected to the gripping portion 322 at the angle θ_{b} with the X-direction. Therefore the configuration of the gripping portion 322 can be changed, which enlarges the application scope of the smart sensorized gripper. With the gripper guideway 324, a range of a forced-to-move distance of the gripping element 32 is increased. The manufacturers can choose different types of the gripping element 32 according to needs.

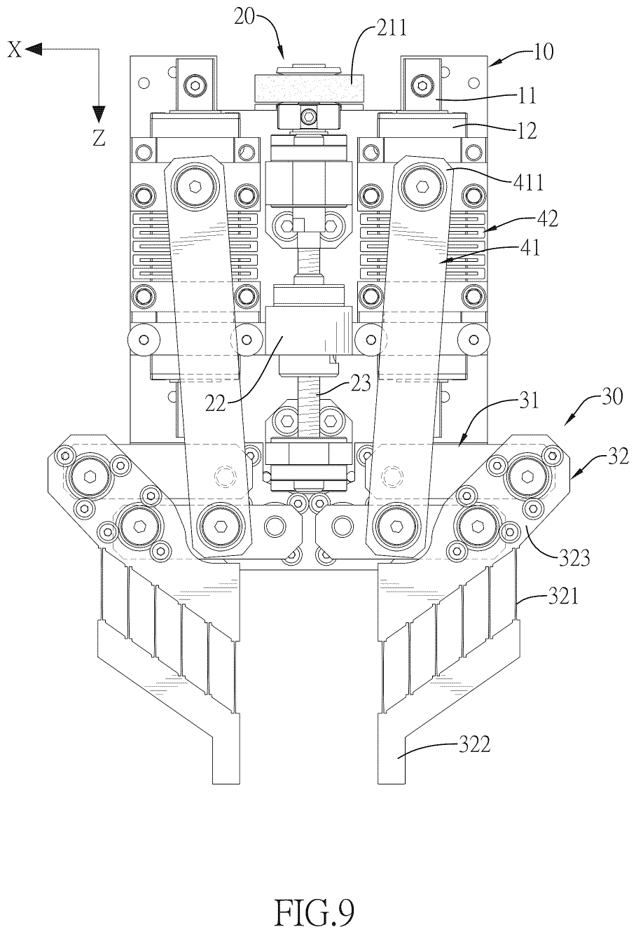

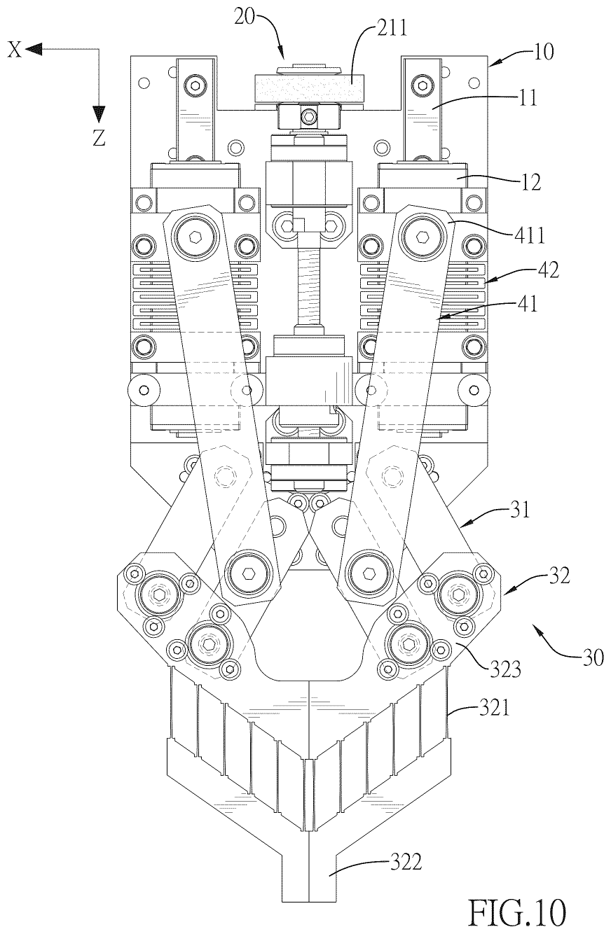

With reference to FIGS. 1, 9 and 10, with the controlling device, the present invention can control the driving element 21 of the driving assembly 20 to operate, rotating the driving screw rod 23 by a driving belt 211 and a belt pulley 212, thereby moving the moving element 22 along the Z-direction. The moving element 22 drives the elastic elements 42 of the two moving assemblies to move along the Z-direction, and the corresponding driven bars 41 are driven to move, thereby rotating the crank elements 31 of the two gripping assemblies 30 with the corresponding driven bars 41 of the two moving assemblies 40. The crank elements 31 will drive the gripping elements 32 to move, and therefore the gripping portions 322 of the gripping elements 32 of the two gripping assemblies 30 are moved toward or away from each other. By that, the smart sensorized gripper can grip or release an object through only one driving element 21 driving the two gripping assemblies 30, simplifying structures and reducing weight and cost.

In addition, by the two angle sensors 50 and the displacement sensor 60, the smart sensorized gripper can provide the controlling device to detect an axial force Fz along the Z-direction and a gripping force Fx along the X-direction that are applied on the gripping portions 322 of the gripping elements 32 of the two gripping assemblies 30. Therefore the controlling device can control a force applied by the smart sensorized gripper and can detect whether the gripping elements 32 collide or not.

The following is a description with simplified figures about how the smart sensorized gripper detects the axial force Fz and the gripping force Fx. A force, applied by the smart sensorized gripper, along the X-direction on an object 70 between the gripping elements 32 is opposite to a direction of the gripping force Fx; a force, applied by the smart sensorized gripper, along the Z-direction on the object 70 is opposite to a direction of the axial force Fz.

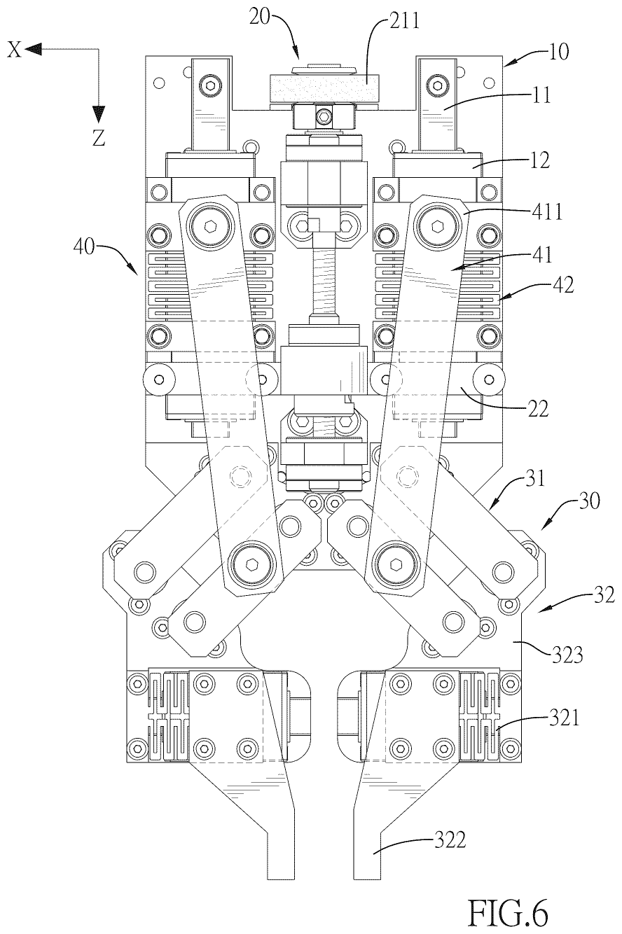

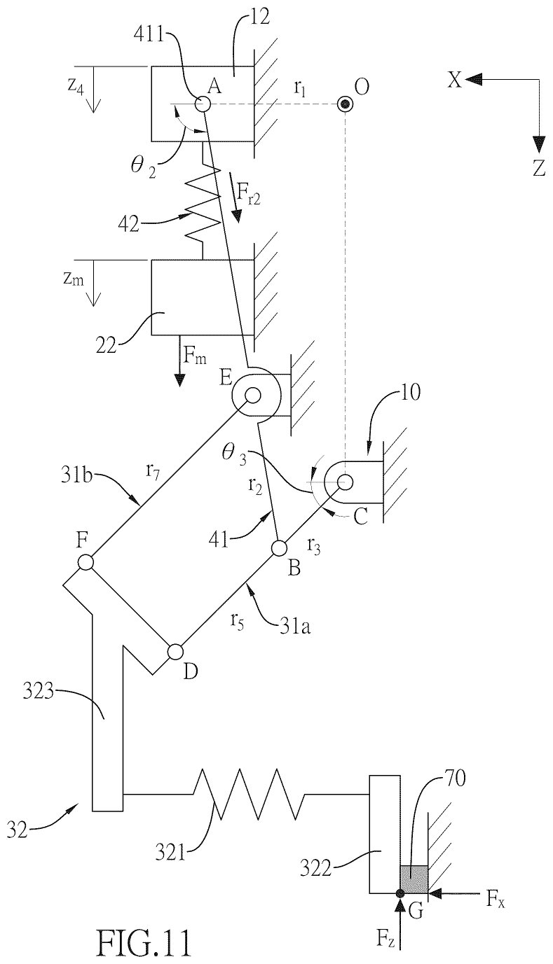

With reference to FIGS. 2 and 6, in the first and second embodiments of the present invention, the elastic portion 321 of the gripping element 32 of each one of the two gripping assemblies 30 is connected to the base-connecting portion 323 along the X-direction. With reference to FIG. 11, a forcing point G is defined at the gripping portion 322 of the gripping element 32. When the gripping portions 322 of the gripping elements 32 of the two gripping assemblies 30 grip or contact the object 70, the gripping portion 322 of the gripping element 32 of each one of the two gripping assemblies 30 receives a reaction force. The description is based on the gripping force Fx and the axial force Fz applied on the forcing point G in the simplified figures.

Besides, because the two gripping assemblies 30 are configured in symmetry, amplitudes of the axial forces Fz respectively received by the two gripping assemblies 30 are equal, and amplitudes of the gripping forces Fx respectively received by the two gripping assemblies 30 are equal. But two directions of the two gripping forces Fx respectively received by the two gripping assemblies 30 are opposite. The description proceeds with one of the two gripping assemblies 30. Furthermore, for conciseness in description, the two crank elements 31 of the gripping assembly 30 are respectively defined as a first crank element 31a and a second crank element 31b, and the first crank element 31a is rotatably connected to the driven bar 41 of the corresponding moving assembly 40.

With reference to FIG. 11, when the gripping portion 322 of the gripping element 32 is forced, an elastic-portion compression x₆ is generated by the elastic portion 321 of the gripping element 32 being compressed; the crank elements 31 and the driven bar 41 are rotated; the moved end 411 of the driven bar 41 is moved; and the elastic element 42 is compressed.

In addition, the gripping force Fx is expressed by an equation below:

F=k₂×x₆

In the above equation, Fₓ is the gripping force; k₂ is an elastic modulus of the elastic portion 321 of the gripping element 32. That means, the gripping force Fx equals the elastic modulus k₂ of the elastic portion 321 of the gripping element 32 multiplied by the elastic-portion compression x₆. The elastic-portion compression x₆ is expressed by an equation below:

x₆=r₇×(cos θ₃ᵢ−cos θ₃)

In the above equation, x₆ is the elastic-portion compression; two ends of the second crank element 31b each respectively have a joint E connected to the gripper base 10 and a joint F connected to the base-connecting portion 323 of the gripping element 32, and r₇ is a length of the second crank element 31b between the joint E and the joint F; 63 is an original angle of the two crank elements 31 that can be set up by the manufacturers according to needs; θ₃ is an after-rotation angle of the crank elements 31 that can be measured by the corresponding angle sensor 50.

By the angle sensor 50 measuring the after-rotation angle of the corresponding crank element 31, the elastic-portion compression x₆ can be calculated, and thus to calculate the gripping force Fx. The controlling device can thus control the gripping force Fx of the smart sensorized gripper by controlling the after-rotation angle of the crank element 31 through the angle sensor 50.

Besides, the axial force Fz is expressed by an equation below:

$${F}_{z} = \frac{{F}_{r 2} \times {r}_{3} \times sin ( {θ}_{2} - {θ}_{3} )}{( {r}_{3} + {r}_{5} ) \times cos {θ}_{3}} - \frac{{k}_{2} \times {x}_{6} \times sin {θ}_{3}}{cos {θ}_{3}}$$

In the above equation, Fᵣ₂ is a force received by the driven bar 41; 62 is an after-rotation angle of the driven bar 41; r₃ is a length of the first crank element 31a between a joint B and a joint C, wherein the joint B is where the first crank element 31a and the driven bar 41 are connected, and the joint C is where the first crank element 31a and the gripper base 10 are connected; r₅ is a length of the first crank element 31a between the joint B and a joint D, wherein the joint D is where the first crank element 31a and the base-connecting portion of the gripping element 32 are connected.

Additionally, the force Fᵣ₂ received by the driven bar 41 is expressed by an equation below:

$${F}_{r 2} = \frac{{k}_{1} \times ( {z}_{m} - {z}_{4} )}{sin {θ}_{2}}$$

In the above equation, k₁ is an elastic modulus of the corresponding elastic element 42 of the driven bar 41, and the driven bar 41 is connected to the said elastic element 42 through a joint A; zₘ is a displacement of the moving element 22 along the Z-direction and can be sensed by the displacement sensor 60; z₄ is a displacement of the moved end 411 of the driven bar 41 along the Z-direction, which is same as a displacement of the joint A along the Z-direction. Additionally, the displacement z₄ of the moved end 411 of the driven bar 41 is expressed by an equation below:

z₄=r₄ᵢ−r₂×sin θ₂+r₃×sin θ₃

In the above equation, r₄ᵢ is an initial length from the joint A to the joint C along the Z-direction, which is same as an initial length between an original point O and the joint C. The original point O is an imaginary datum point defined to facilitate analysis of linkage mechanism by vector loop method. The original point O is parallel to the joint A along the X-direction and is parallel to the joint C along the Z-direction. r₂ is a length of the driven bar 41 between the joint A and the joint B. The initial length r₄ᵢ between the joint A and the joint C along the Z-direction is expressed by an equation below:

r₄ᵢ=r₂×sin θ₂ᵢ−r₃×sin θ₃ᵢ

In the above equation, θ₂ᵢ is an initial angle of the driven bar 41 and can be set up by the manufacturers according to needs. The after-rotation angle θ₂ of the driven bar 41 is expressed by an equation below:

$${θ}_{2} = {cos}^{- 1} [ \frac{{r}_{3} \times cos {θ}_{3} - {r}_{1}}{{r}_{2}} ]$$

In the above equation, r₁ is a length between the joint A and the original point O, which is same as a length between the joint A and the joint C along the X-direction. Therefore, by the above-mentioned equations, it is known that the controlling device can control the after-rotation angle of the crank element 31 through the angle sensor 50. And the controlling device can control the displacement of the moving element 22 along the Z-direction through the displacement sensor 60 and through controlling the driving element 21, thereby controlling the axial force Fz of the smart sensorized gripper.

By sensing with the angle sensors 50 and controlling the driving element 21 to drive, the controlling device can control rotation angles of the crank elements 31 to control the gripping force Fx along the X-direction without being affected by the axial force Fz. After obtaining an amplitude of the gripping force Fx by sensing with the angle sensors 50 and obtaining the displacement zₘ of the moving element 22 moved by the driving element 21 with the displacement sensor 60, the controlling device can control the axial force Fz along the Z-direction, thereby controlling the axial force Fz without being affected by a change of the gripping force Fx. During the course of monitoring the change of the gripping force Fx while controlling the axial force Fz, the smart sensorized gripper can facilitate the controlling device to respectively control and detect the gripping force Fx and the axial force Fz, thus increasing the functionality of the present invention.

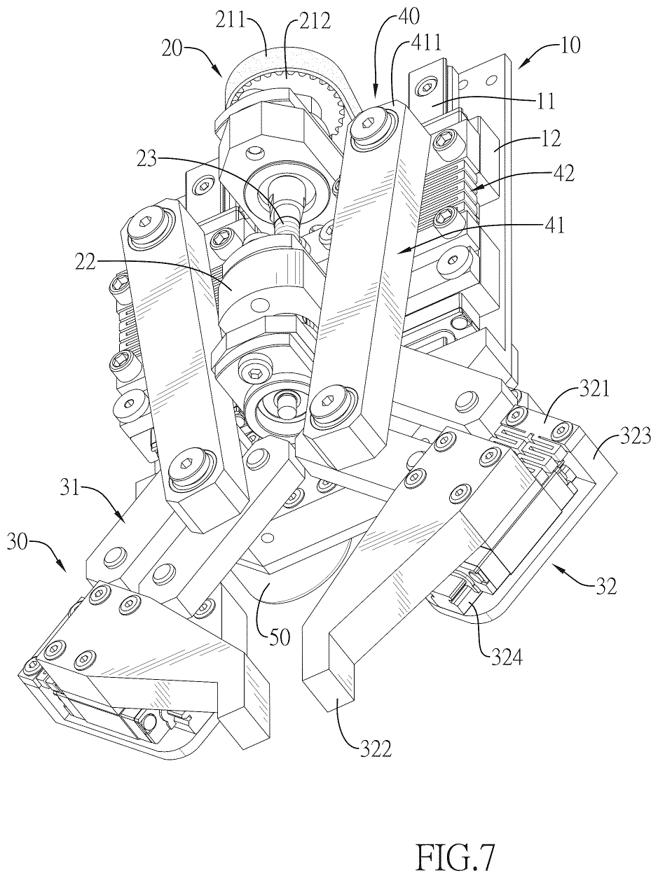

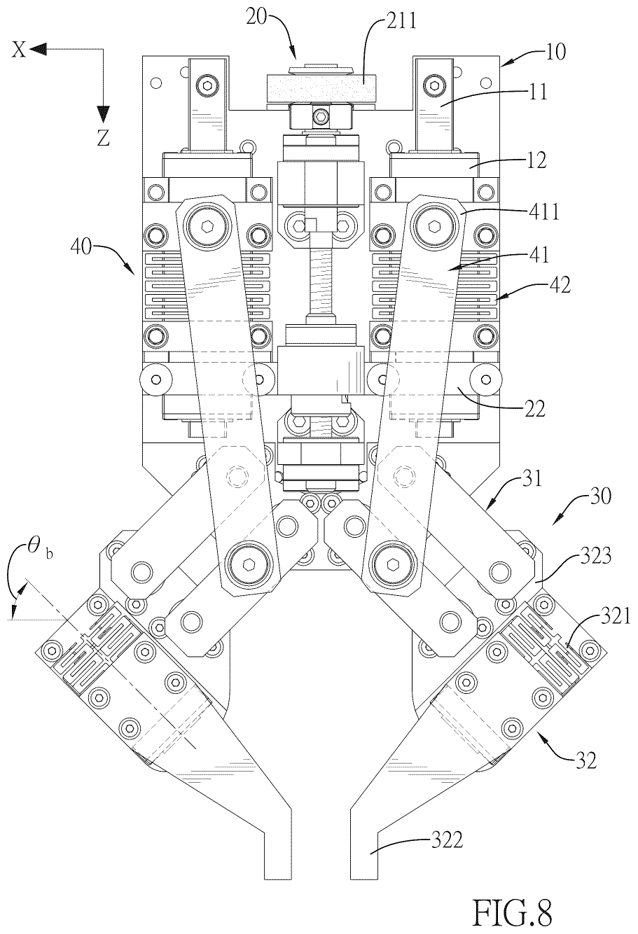

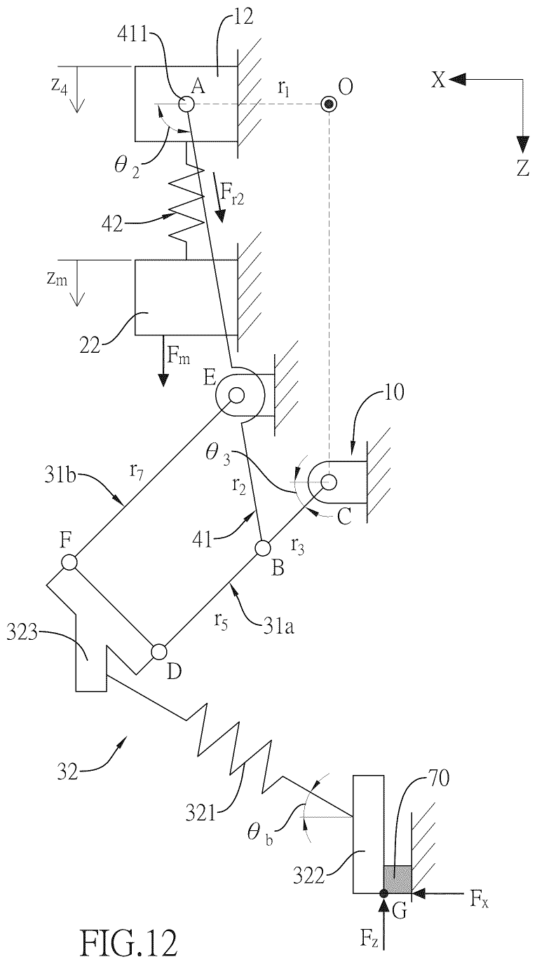

Besides, with reference to FIGS. 7 and 8, in the third embodiment of the present invention, the elastic portion 321 of the gripping element 32 of each one of the two gripping assemblies 30 is connected to the gripping portion 322 along the direction that is at the angle θ_{b}, with the X-direction. The angle θ_{b}, is between 0 and 90 degrees, endpoints excluded. Additionally, with reference to FIG. 12, when the two ends of the elastic portion 321 are respectively connected to the gripping portion 322 and the base-connecting portion 323 along the direction that is at the angle θ_{b}, with the X-direction, the gripping force Fx is expressed by an equation below:

Fₓ=k₂×x₆×cos θ_{b}

In the above equation, Fx is the gripping force; θ_{b} is an angle between the direction, along which the two ends of the elastic portion 321 of the gripping element 32 extend, and the X-direction. The rest symbols are described in the above paragraphs so description thereof will not be repeated here. The axial force Fz is expressed by an equation below:

$${F}_{z} = \frac{{F}_{r 2} \times {r}_{3} \times sin ( {θ}_{2} - {θ}_{3} )}{( {r}_{3} + {r}_{5} ) \times cos {θ}_{3}} - \frac{{k}_{2} \times {x}_{6} \times cos {θ}_{b} \times sin {θ}_{3}}{cos {θ}_{3}}$$

In the above equation, F_{z} is the axial force, and the rest symbols are described in the above paragraphs and are obtained through the same equations so description thereof will not be repeated here.

As known from the above equations, regardless of the elastic portion 321 of the gripping element 32 is connected to the gripping portion 322 and the base-connecting portion 323 along the X-direction or along the direction at the angle θ_{b} with the X-direction, the measurement of the axial force Fz and the gripping force Fx by the smart sensorized gripper is not affected. Therefore the structural design of the smart sensorized gripper can be adjusted according to manufacturers' needs.

By sensing the axial force Fz and the gripping force Fx, the smart sensorized gripper can be used for detection of accidental collision. When a moving route or a moving environment of the smart sensorized gripper driven by the controlling device is abnormal, making the gripping elements 32 collide, the gripping elements 32 would encounter a reaction force. By that, the controlling device detects changes of the axial force Fz and the gripping force Fx and can judge the collision is from the Z-direction or the X-direction, thereby moving the smart sensorized gripper to avoid collision.

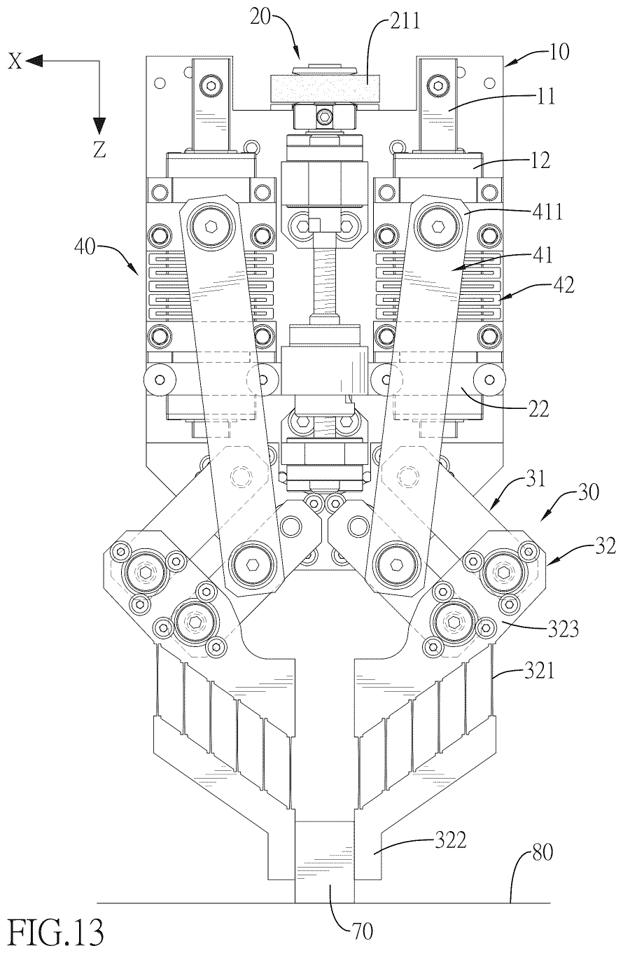

With reference to FIG. 13, when the gripping elements 32 of the two gripping assemblies 30 contact a loading plate 80 under the object 70, the controlling device can drive the smart sensorized gripper to move upward along the Z-direction. This ensures a precise gripping position, thereby increasing the positioning precision. Additionally, when the base-connecting portion 323 or the elastic portion 321 of the gripping element 32 collides, the gripping element 32 is moved by the collision, which rotates the crank element 31 and makes the angle sensor 50 sense an angle change. Therefore the controlling device can distinguish a direction of the collision occurring to the smart sensorized gripper to avoid further colliding.

When the smart sensorized gripper grips the object 70 to lift it from the loading plate 80, by sensing the axial force Fz, a weight of the object 70 can be measured, and a width dimension of the object 70 along the X-direction can be measured by conversion from the gripping force Fx. When the smart sensorized gripper puts the object 70 down on the loading plate 80, the object 70 contacts the loading plate 80 along the Z-direction, changing the axial force Fz, therefore increasing the precision of the smart sensorized gripper while loading the object 70. Furthermore, the smart sensorized gripper does not need to load the object 70 by throwing it or presetting moving routes, and can avoid collision occurring to the object 70, thereby enlarging the scope of application.

Besides, the two gripping assemblies 30 of the smart sensorized gripper are respectively connected to the two angle sensors 50, therefore the gripping forces Fx respectively received by the gripping elements 32 of the two gripping assemblies 30 can be detected respectively. By that, when any side of the object 70 is gripped by the smart sensorized gripper contacting another object 70 along the X-direction, a change occurs to the gripping force Fx received by the gripping element 32 of the gripping assembly 30 at the same side of the contacted side of the object 70, so the controlling device determines that the object 70 is colliding. Alternatively, when loading the object 70 at a loading position such as a hole that is surrounded by walls, the controlling device can readjust dislocation or incline of the object 70. Alternatively, when the loading position is mounted with positioning structures, through changes of the gripping force Fx caused by the object 70 contacting the positioning structures, whether the object 70 arrives at the loading position can be confirmed.

Furthermore, because the two angle sensors 50 and the displacement sensor 60 are respectively mounted at the gripper base 10, there is no need to install electrical wirings on the gripping elements 32, thereby simplifying the wiring structure and reducing the production cost. When gripping the object 70, the two angle sensors 50 and the displacement sensor 60 do not directly contact the object 70, thereby avoiding an effect from the gripping force Fx. In addition, the two angle sensors 50 and the displacement sensor 60 sense the mechanical operation, i.e., the rotation angles of the crank elements 31 and the displacement of the moving element 22, cooperating with the existing optical encoder that has higher measuring precision of angle and distance, the precision and reliability of detection of the smart sensorized gripper are both enhanced.

Moreover, the gripping portion 322 of the gripping element 32 of the gripping assembly 30 is connected by the elastic portion 321. As the elastic portion 321 is elastically deformable, the gripping element 32 can provide a soft gripping touch like a soft gripper while maintaining the stiffness, which provides a buffer to the gripping portion 322 of the gripping element 32 when contacting the object 70 or when colliding, therefore to avoid damage to the smart sensorized gripper or the object 70. And by the elastic deformation of the elastic portion 321 of the gripping element 32, a positioning error within a certain range can be overcome, so that the smart sensorized gripper can smoothly grip the object 70.

Besides, in a preferable embodiment of the present invention, the smart sensorized gripper is disclosed as having a two-finger mechanical structure composed by the two gripping assemblies 30. However, the equations and the force analysis for the axial force Fz and the gripping force Fx provided by the present invention and the simplified figures of linkage mechanism can be applied on a multi-finger mechanical structure composed by multiple gripping assemblies 30, without being limited to the two-finger mechanical structure.

To sum up, by the two angle sensors 50 and the displacement sensor 60, the smart sensorized gripper can detect the axial force Fz and the gripping force Fx respectively received by the gripping elements 32 of the two gripping assemblies 30. By that, the controlling device can respectively control the axial force Fz and the gripping force Fx through the driving element 21, thereby increasing the functionality and the positioning precision. Additionally, by the two angle sensors 50 and the displacement sensor 60 respectively mounted on the gripper base 10, no extra electrical wirings are needed on the two gripping assemblies 30, simplifying the wiring structure and reducing the production cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the board general meaning of the terms in which the appended claims are expressed.

What is claimed is:

1. A smart sensorized gripper configured to be electrically connected to and controlled by a controlling device; the smart sensorized gripper having a Z-direction and comprising:
a gripper base;
a driving assembly mounted at the gripper base, and comprising
a driving element electrically connected to and controlled by the controlling device;
a moving element connected to and driven by the driving element to move linearly along the Z-direction;
two gripping assemblies mounted at the gripper base, and being opposite to each other; each one of the two gripping assemblies comprising
two crank elements parallel to each other, and rotatably mounted at the gripper base respectively;
a gripping element connected to the two crank elements, and having
an elastic portion;
a gripping portion connected to the elastic portion and disposed at an end, which is away from the crank elements, of the gripping element;
two moving assemblies mounted at the gripper base, and being opposite to each other; each one of the two moving assemblies corresponding to a respective one of the two gripping assemblies and comprising
a driven bar, having
a moved end linearly and movably mounted on the gripper base,
a pivot end being opposite to the moved end, and rotatably connected to one of the two crank elements of the corresponding gripping assembly;
an elastic element, having two ends along the Z-direction, and the two ends of the elastic element respectively connected to the moving element and the moved end of the driven bar;
two angle sensors mounted at the gripper base, electrically connected to the controlling device, and respectively corresponding to the two gripping assemblies; each one of the two angle sensors configured to sense an angle of a respective one of the two crank elements of the corresponding gripping assembly; and
a displacement sensor mounted at the gripper base, electrically connected to the controlling device, and configured to sense a displacement of the moving element.

2. The smart sensorized gripper as claimed in claim 1, wherein the smart sensorized gripper has an X-direction perpendicular to the Z-direction; the elastic portion of the gripping element of each one of the two gripping assemblies is connected to the gripping portion along the X-direction.

3. The smart sensorized gripper as claimed in claim 1, wherein the smart sensorized gripper has an X-direction perpendicular to the Z-direction; the elastic portion of the gripping element of each one of the two gripping assemblies is connected to the gripping portion along a direction nonparallel with the X-direction, and an angle between the said direction and the X-direction is between 0 and 90 degrees, endpoints excluded.

4. The smart sensorized gripper as claimed in claim 1, wherein
the two moving assemblies are respectively disposed at two sides of the driving assembly; and
the two gripping assemblies are respectively disposed at the two sides of the driving assembly.

5. The smart sensorized gripper as claimed in claim 2, wherein
the two moving assemblies are respectively disposed at two sides of the driving assembly; and
the two gripping assemblies are respectively disposed at the two sides of the driving assembly.

6. The smart sensorized gripper as claimed in claim 3, wherein
the two moving assemblies are respectively disposed at two sides of the driving assembly; and
the two gripping assemblies are respectively disposed at the two sides of the driving assembly.

7. The smart sensorized gripper as claimed in claim 1, wherein
the driving assembly comprises
a driving screw rod mounted at the gripper base and connected to the driving element;
the gripper base has
two axial guideway rails;
the moving element is screwed on the driving screw rod and is movably mounted on the two axial guideway rails; and
the driving element rotates the driving screw rod, thereby moving the moving element on the driving screw rod and the two axial guideway rails along the Z-direction.

8. The smart sensorized gripper as claimed in claim 2, wherein
the driving assembly comprises
a driving screw rod mounted at the gripper base and connected to the driving element;
the gripper base has
two axial guideway rails;
the moving element is screwed on the driving screw rod and is movably mounted on the two axial guideway rails; and
the driving element rotates the driving screw rod, thereby moving the moving element on the driving screw rod and the two axial guideway rails along the Z-direction.

9. The smart sensorized gripper as claimed in claim 3, wherein
the driving assembly comprises
a driving screw rod mounted at the gripper base and connected to the driving element;
the gripper base has
two axial guideway rails;
the moving element is screwed on the driving screw rod and is movably mounted on the two axial guideway rails; and
the driving element rotates the driving screw rod, thereby moving the moving element on the driving screw rod and the two axial guideway rails along the Z-direction.

10. The smart sensorized gripper as claimed in claim 4, wherein
the driving assembly comprises
a driving screw rod mounted at the gripper base and connected to the driving element;
the gripper base has
two axial guideway rails disposed at two sides of the driving screw rod respectively,
the moving element is screwed on the driving screw rod and is movably mounted on the two axial guideway rails; and
the driving element rotates the driving screw rod, thereby moving the moving element on the driving screw rod and the two axial guideway rails along the Z-direction.

11. The smart sensorized gripper as claimed in claim 5, wherein
the driving assembly comprises
a driving screw rod mounted at the gripper base and connected to the driving element;
the gripper base has
two axial guideway rails disposed at two sides of the driving screw rod respectively;
the moving element is screwed on the driving screw rod and is movably mounted on the two axial guideway rails; and
the driving element rotates the driving screw rod, thereby moving the moving element on the driving screw rod and the two axial guideway rails along the Z-direction.

12. The smart sensorized gripper as claimed in claim 6, wherein
the driving assembly comprises
a driving screw rod mounted at the gripper base and connected to the driving element;
the gripper base has
two axial guideway rails disposed at two sides of the driving screw rod respectively,
the moving element is screwed on the driving screw rod and is movably mounted on the two axial guideway rails; and
the driving element rotates the driving screw rod, thereby moving the moving element on the driving screw rod and the two axial guideway rails along the Z-direction.

13. The smart sensorized gripper as claimed in claim 10, wherein
the moved end of the driven bar of each one of the two moving assemblies is mounted on a respective one of the two axial guideway rails; and
a distance between the moved end of the driven bar and the driving screw rod is longer than a distance between the pivot end of the driven bar and the driving screw rod.

14. The smart sensorized gripper as claimed in claim 11, wherein
the moved end of the driven bar of each one of the two moving assemblies is mounted on a respective one of the two axial guideway rails; and
a distance between the moved end of the driven bar and the driving screw rod is longer than a distance between the pivot end of the driven bar and the driving screw rod.

15. The smart sensorized gripper as claimed in claim 12, wherein
the moved end of the driven bar of each one of the two moving assemblies is mounted on a respective one of the two axial guideway rails; and
a distance between the moved end of the driven bar and the driving screw rod is longer than a distance between the pivot end of the driven bar and the driving screw rod.

16. The smart sensorized gripper as claimed in claim 1, wherein
the gripping element of each one of the two gripping assemblies has
a base-connecting portion connected to the two crank elements; and
a gripper guideway mounted on the base-connecting portion; and
one end of the elastic portion is connected to the base-connecting portion, and another end of the elastic portion is movably mounted at the gripper guideway and is connected to the gripping portion.

17. The smart sensorized gripper as claimed in claim 11, wherein
the gripping element of each one of the two gripping assemblies has
a base-connecting portion connected to the two crank elements; and
a gripper guideway mounted on the base-connecting portion; and
one end of the elastic portion is connected to the base-connecting portion, and another end of the elastic portion is movably mounted at the gripper guideway and is connected to the gripping portion.

18. The smart sensorized gripper as claimed in claim 12, wherein
the gripping element of each one of the two gripping assemblies has
a base-connecting portion connected to the two crank elements; and
a gripper guideway mounted on the base-connecting portion; and
one end of the elastic portion is connected to the base-connecting portion, and another end of the elastic portion is movably mounted at the gripper guideway and is connected to the gripping portion.

19. The smart sensorized gripper as claimed in claim 14, wherein
the gripping element of each one of the two gripping assemblies has
a base-connecting portion connected to the two crank elements; and
a gripper guideway mounted on the base-connecting portion; and
one end of the elastic portion is connected to the base-connecting portion, and another end of the elastic portion is movably mounted at the gripper guideway and is connected to the gripping portion.

20. The smart sensorized gripper as claimed in claim 15, wherein
the gripping element of each one of the two gripping assemblies has
a base-connecting portion connected to the two crank elements; and
a gripper guideway mounted on the base-connecting portion; and
one end of the elastic portion is connected to the base-connecting portion, and another end of the elastic portion is movably mounted at the gripper guideway and is connected to the gripping portion.
